(19) United States
(12) Patent Application Publication
(10) Pub. No.: US 2016/0324602 A1
(43) Pub. Date: Nov. 10, 2016

(54) ABUTMENT SYSTEM FOR IMMEDIATE IMPLANTS

(71) Applicant: OLISTA AG, Küsnacht (CH)

(72) Inventors: Oliver HANISCH, Paris (FR); Stefan PAUL, Zürich (CH)

(73) Assignee: OLISTA AG, Küsnacht (CH)

(21) Appl. No.: 15/109,041

(22) PCT Filed: Dec. 30, 2013
(86) PCT No.: PCT/EP2013/003922

§ 371 Date: Jun. 29, 2016

(51) Int. Cl. A61C 8/00; A61C 8/02

(52) U.S. Cl. CPC A61C 8/0098; A61C 8/0006; A61C 8/0077; A61C 8/0054; A61C 8/0087; A61C 8/0089; A61C 2008/0084; A61C 2008/0046

(57) ABSTRACT

An abutment system for use in the area of anterior teeth and premolar teeth with an abutment basis. The system includes a first interface for placement onto an implant and a further interface for attaching a post. The abutment basis has a three-dimensional shape, which is not symmetrically designed with respect to the implant axis. The implant defines the implant axis. The abutment basis is designed as a one-time abutment basis. The abutment system includes a separate insertion post, which is attachable in the region of an upper surface of the abutment basis. The insertion post, in the attached state, extends coaxially with respect to the implant axis. The upper surface of the abutment basis is a scalloped upper surface and the further interface for attaching the insertion post is located within the area of the scalloped upper surface.

The invention concerns an abutment system for establishing an implant-supported dental prosthesis. In particular, abutment systems for single implants are concerned that are applied in the area of the frontal row of teeth or premolars.

### STATE OF THE ART

It is known that one may have lost or extracted teeth replaced by implant-supported dental prosthesis. So-called osseointegrated implants are employed for more than 40 years. In case of a skilfully handled osseointegration a stable implant-bone composition results. In case of posterior arranged teeth the restoration primarily concerns the preservation or the reconstruction of the chewing function. In the visible area, however, also the aesthetics and in particular the preservation of the soft tissue are concerned.

FIG. 1A shows a schematic frontal view of two human anterior teeth FZ: 21 and FZ: 11 together with the surrounding gingiva. A first vertical section through one of the anterior teeth FZ: 11 and the surrounding structures are shown in an oversimplified form in FIG. 1B. A second vertical section through the same anterior tooth FZ: 11 is shown in FIG. 1C, whereat the second vertical section is perpendicular with respect to the first vertical section.

Essential terms are being explained in connection with FIGS. 1A through 1C since in the following reference is made repeatedly to the anatomy of teeth. The tooth FZ as such is composed of the dentin 11 and it is surrounded in the upper (mostly visible) area by dental enamel 7. The respective cemento-enamel junction SZG typically has a scalloped shape, as indicated in FIG. 1B. The root of the tooth 12 sits in an alveolus of the jawbones 5. If viewed from the outside to the inner side the so-called gingiva (epithelium) 9 sits on the connective tissue 6. Collagen fibres 14 are arranged inside the connective tissue 6. On the top left some of these collagen fibres 14 are indicated in FIGS. 1B and 1C. The fibres 14 surround the tooth FZ in a ring or loop shape or rather insert perpendicularly on the root surface as soft tissue attachment (if viewed from the top). The parodont 13 is situated between the jawbone 5 and root of the tooth 12 consisting of root dentin. The root dentin on the outer side is covered by a thin layer of root cement. The nerve 8 sits inside the tooth FZ.

In FIG. 2A a strongly schematized section of a molar tooth BZ: 16 and a premolar PM: 15 of the upper jaw of a human denture including the surrounding soft tissue morphology right underneath the cemento-enamel junction SZG is shown as example. One can see the gingiva 9 and the connective tissue 6 in FIG. 2A. The orientation of the collagen fibres 14 in the connective tissue 6 is indicated by lines/curves, whereat the collagen fibres 14 enclose the two teeth BZ and PM in a ring- or loop shape and insert on the root surface, too. Inside the two teeth BZ and PM one can see in the section the internal channel of the nerve 8 and the surrounding root dentin of the root of the tooth 12. A thin layer of the root cement is located on the outside on the root dentin of the root of the tooth 12, what is not separately illustrated here.

FIG. 2B shows as an example a schematic view of the upper jaw of a human denture from the bottom.

After the loss or the extraction of a tooth FZ in the most frontal area of the jaw and the insertion of an implant, sometimes the reduction of the gingiva 9 and/or jawbone 5 can be determined already after a short period. In this context it matters whether the implant was inserted with a time delay or whether it was implanted in the context of an immediately placed implant right after the extraction of the tooth FZ. One can assume that the connective tissue 6 and the contour/structure of the enveloping collagen fibres 14 are still sound if the tooth FZ is still in place and if an extraction is for instance advisable because of a local infection or a trauma. The immediate insertion of the implant into the extraction alveolus and the immediate insertion of an abutment including provisional restoration can be advantageous in these cases. These so-called immediate-immediate techniques are thus gaining in importance for the insertion of dental implants, although until now the delayed-immediate approach is the most widely used implant technology (Lang et al, 2012, Esposito et al, 2010).

Background of this immediate-immediate implant technique in connection with the immediate restoration by a provisional restoration is the fact that by inserting an abutment (as intermediate element, which is placed in the soft tissue region, between the implant and the restoration) the collagenous connective tissue structure and therefore the gingiva contour is supported.

Common practice by today is that for the production of the definite dental prosthesis the primary abutment (healing and/or provisional abutment) is exchanged several times and is replaced by a final abutment during the insertion of the definite restoration. This final abutment is individually manufactured along with the definite dental prosthesis after taking an impression. It turned out that by the exchange of the primary and the final abutment the destruction of the soft tissue adhesion between connective tissue and abutment contact area appears. This traumata leads to a peri-implant bone loss.

Unlike implants, final abutments are non-sterile packed by the manufacturer until today. The clinically accepted procedure stipulates that abutments are disinfected using disinfectants or are sterilized in the autoclave before inserted into the patient. Both procedures do not show sufficient decontamination from microorganisms and additionally lead to changes in the abutment contact areas, which reduce the connective tissue adhesion (Canullo et al, 2013, Vezeau et al, 2000, Steinemann 1998, Rowland et al, 1995).

The insertion of an abutment is until today also not recommended—contrary to implants—under sterile conditions.

In case of a classic tooth replacement implant, the implant is completely situated epi- or subcrestal. The old school until today prevails that dental implants have to be inserted so that the upper edge of the implant is situated at or (only a little) underneath the upper most level KN1 of the surrounding bones (see for instance FIG. 1C) of the jawbone 5. This is, inter alia, justified by the desire to prevent, in case of a recession of the bones 5 and the soft tissues 6, 9, that the upper edge of the implant becomes visible.

Different strongly schematized views of a prior known implant 1 and abutment 2 are shown in FIGS. 3A through 3C as schematic diagrams. Typically an abutment 2 is employed as intermediate element between a supra construction and/or crown and the implant 1, as shown by means of the FIGS. 3A through 3C in a strongly schematized form. Making reference to FIG. 1B, the abutment 2 typically sits in the region of the penetration point through the soft tissue (connective tissue 6 and epithelium 9), whereat the interface between the implant and abutment lies epi- or subcrestal, depending on the height where the implant was situated. Until now, abutments 2 that have rotationally symmetric basic shape are often employed. However, due to their rotationally symmetric basic shape, such abutments 2 have, inter alia, the disadvantage that they cannot be integrated into a row of teeth in an optimum position and that thus the production of the supra construction is made difficult and in some cases even impossible, since natural anterior (FZ) and premolar (PM) teeth in the region of the cemento-enamel junction SZG have a deltoid and oval root cross-section, respectively. An adaptation (“grinding”) inside the patient's mouth is almost impossible because of the hard material of the abutment 2. Such problems, however, do not exist in case of abutments produced individually in a laboratory. However, this results in a high cost and time effort.

As can be seen in FIGS. 3A and 3C, the abutments 2 so far often have a flat upper side 3. Very recently, there are also some abutments 2 with a so-called scalloped (rolling or saddle-shaped) upper surface 4, as can be seen in FIG. 4. In case of this known solution the scalloped upper surface 4 approximately assumes the shape of a natural cemento-enamel junction SZG of the tooth FZ that was extracted before.

For instance, there already exists a scalloped implant 10, which is schematically illustrated in FIG. 4, that is offered by the Noble Biocare Company, Sweden, under the name NobelPerfect™. This concerns a one-piece implant 10 where the implant 1 as such and the abutment 2 are implemented as one piece. The NobelPerfect™ implant 10 is rotationally symmetric with respect to the implant axis AI, as can be seen in FIG. 4. The abutment section 2 of the implant 10 is rotationally symmetric, too, and it has a hat shape. Details of such a scalloped implant 10 can for instance be derived from U.S. Pat. No. 6,174,167 B1. In the letters patent U.S. Pat. No. 6,174,167 B1 an implant is described comprising a scalloped surface with bulges and depressions so as to reproduce the physiological contour of the natural bone-tissue-morphology. U.S. Pat. No. 6,174,167 B1 shows a two-part solution, the implant-abutment interface having a scalloped surface. The scalloped surface according to U.S. Pat. No. 6,174,167 B1 is symmetric. The abutment according to U.S. Pat. No. 6,174,167 B1 has a conical subgingival lateral area.

From the letters patent U.S. Pat. No. 5,810,592 one- and two-piece abutment systems having an asymmetric shoulder and a conical subgingival lateral area are known. The abutment system according to U.S. Pat. No. 5,810,592 is designed for assuming a supracrestal position. The letters patent U.S. Pat. No. 5,810,592 does neither show a scalloped surface having an apex nor a concave lateral area if viewed in the vertical section.

The published international patent application WO 2006/138351 describes an abutment system that has a kind of asymmetric scallop and concave/convex subgingival lateral areas. The abutment according to WO 2006/138351 is not a two-piece abutment.

The published applications WO2004/037110 and JP2008/149121 describe abutment systems, where the implant body has a cervical part. Thereto an abutment can be attached. Established implants consist of one piece instead of two pieces. In both applications, the mentioned cervical part has a surface designed for osseointegration, i.e., for bone integration. The cervical part is therefore not designed for the apposition of soft tissue. Moreover, the subgingival lateral area has only conical areas.

A further implant is known from the European patent application EP 1205158 A1, its shape being adapted to the differences of level of the progression of the jawbone. In accordance with this patent application, the implant is widened at opposite regions at its distal end. This implant shows an inner recess that is shaped in accordance with the widening. I.e., the implant is hollow at least in the upper area. A correspondingly shaped platform body, which serves as abutment, can be inserted into this recess. The interface between implant and abutment is inside.

It is a disadvantage of this solution that the implant as such is adapted in a certain way to the difference of level of the progression of the jawbone. The implant thus has to be inserted exactly so that its widening with respect to the progression of the jawbone assumes an optimum position. The implant is not in the optimum position if it is not screwed in far enough or too far.

It is an object to provide an abutment system and an implant constructed thereon that facilitate/s an implantation procedure where no or only a marginally small recession at the gingiva and/or jawbone occurs. Furthermore, aesthetically appealing and durable tooth replacement solutions shall be facilitated first of all for anterior and premolar teeth.

In particular, the invention concerns providing an abutment system having an optimal anatomic basic form and contour analogous to the extracted tooth.

The invention also concerns providing an abutment system allowing for a good “integration” into the soft tissue. The invention deals in particular with the improved soft tissue desorption of the anatomically formed abutment basis.

The abutment system according to the invention thus has a hydrophilic or ultra-hydrophilic contact area, which allows an improved soft tissue adhesion.

The abutment system according to the invention has a lateral area, whose smooth and/or micro-rough soft tissue contact area is designed hydrophilic or ultra-hydrophilic.

The abutment system according to the invention is designed as abutment that can be inserted once. Thus, this concerns a so-called one-time abutment that is once and therefore finally inserted (during implantation or rather implant opening), and that is not exchanged in the course of the production of the definite restoration anymore.

The invention is based on the finding that for abutment systems being designed for a multiple exchange before a final abutment is inserted, bone resorption can appear. Several studies have shown that the one-time insertion of a final abutment leads to a reduced bone resorption compared to the traditional procedure including an exchange between primary and final abutment (Grandi et al, 2012, Rodriguez et al, 2013, Degidi et al, 2011).

The one-time abutment according to the invention is provided sterile packed. The abutment can, e.g., be delivered sterile packed by the manufacturer.

It could be shown clinically that, e.g., titanium abutments sterilized using argon plasm lead to reduced peri-implant bone loss compared to abutments treated using an autoclave. For this reason, an abutment according to the invention (e.g. by the manufacturer) shall be sterilized using adequate techniques (e.g. argon plasm and so on) and shall be provided suitably packed.

Furthermore, in accordance with the invention, a sterile operation area shall be created on the one hand and a contamination of the abutment contact area shall be prevented on the other hand.

For this reason, the one-time abutment according to the invention is designed for being inserted into the extraction alveole with the help of an insertion post. This serves for preventing a contamination of the contact area facing the soft tissue during the insertion.

Furthermore, in accordance with the invention, at least the hydrophilic or the ultra-hydrophilic region of the contact area is designed concave leading to this sensitive surface being protected.

To avoid a contact of the abutment contact area with gloves or saliva, the abutment is inserted by means of an insertion post. This insertion post is preferably pre-mounted onto the abutment and included in the sterile packaging in all embodiments according to the invention.

The insertion post is designed such that the 3-dimensional positioning of the abutment in the mouth is facilitated.

In accordance with the invention an abutment system is concerned for use in the region of anterior and premolar teeth with a standard abutment basis having a first interface for attaching onto a (standard-) implant and a further interface for releasably fixing an insertion post (e.g. a crown or supra construction). This further interface can also serve as interface for fixing a prosthetic element. The abutment basis comprises a scalloped upper surface. The further interface is arranged in the region of the scalloped upper surface.

The abutment system of the invention is in principle independent of the first interface between the (standard-) implant and the abutment and is in principle also independent of the further interface, which serves to removably attach the insertion post. The abutment system of the invention can be adapted to nearly all interfaces.

The implant defines a so-called implant axis after the insertion. The abutment system of the invention is characterized in that the abutment basis has a three-dimensional shape not being symmetrical with respect to this implant axis, i.e., the three-dimensional shape of the abutment basis thus is not a body of rotation. Furthermore, the abutment basis has a lateral area having a concave shape if viewed in a vertical section.

The abutment system can comprise, in addition to the abutment basis, a separate prosthetic post, which can be fixed in the region of the scalloped upper surface of the abutment basis such that the prosthetic post in the fixed state extends coaxially with respect to the implant axis. The prosthetic post serves for attaching a prosthetic element.

The abutment basis has, in all embodiments, a three-dimensional asymmetric shape that is designed to essentially approximate, in the mesial, distal, vestibular and palatial direction, the shape of the cemento-enamel junction SZG. Thus, the abutment basis of the invention is also referred to as anatomically shaped abutment basis.

The abutment basis has, in all embodiments, a three-dimensional concave lateral area that provides for a smooth transition between a rotationally symmetric interface area (in the region of the first interface) and a non-symmetric, circumferential ridge/shoulder or a non-symmetric, scalloped surface. At least a part of this concave lateral area is designed hydrophilic.

The concave lateral area provides a kind of waist of the abutment basis along the progression of the scalloped cemento-enamel junction SZG, which leads to a better integration into the surrounding tissue structure.

The concave envelope area has, partially or completely, a smooth and/or rough contact area to the soft tissue. In accordance with the invention, this contact area is designed such that it shows hydrophilic or ultra-hydrophilic characteristic for achieving a better soft tissue adhesion.

In order to achieve a better soft tissue adhesion, the abutment basis must be sterilized in all embodiments. It has been shown that only industrially applied methods lead to a decontaminated and intact contact area of the abutment basis. Thus, the abutment basis is industrially sterilized and provided with intact, hydrophilic or ultra-hydrophilic contact area. Preferably, the supply is realized by the manufacturer. The sterilization processes commonly applied in a dental surgery do not achieve the same effects and damage the contact area, which was especially designed for better soft tissue adhesion.

Plasma sterilization processes (e.g. argon plasma sterilization) are particularly suitable as sterilization processes for the abutment basis and the insertion post.

According to the invention, the abutment basis is inserted by means of an insertion post under sterile conditions to avoid a contamination of the abutment basis during the insertion. Preferably in all embodiments, this insertion post is pre-mounted onto the abutment and is included in the sterile packaging.

Primarily concerned are abutment basis that are fixed on implants after these have been inserted into the bone of the upper jaw or lower jaw. A removable or basis-fixed dental prosthesis can be anchored on or at these abutment basis. In accordance with the invention the fixing of the dental prosthesis occurs by means of a prosthetic post, which is designed separately from the respective abutment basis.

In particular the so-called immediate implantation is herein concerned where immediately or delayed after the extraction of a tooth or tooth remainder the implant is implanted in the bone of the upper jaw or lower jaw and an abutment basis is attached thereon.

In accordance with the invention, the immediate implantation is preferred in order to preserve the soft tissue morphology. In particular, the preservation of the gingival situation is concerned by employing a special abutment system, which, for instance, is fixed on a commercially available implant, i.e., a two-piece abutment system with post and abutment basis is concerned.

Condition for a soft tissue adhesion is the single insertion of the one-time abutment. This one-time abutment is not exchanged after the insertion and remains as final abutment in the mouth. The impression for the dental prosthesis is carried out on the level of the abutment basis due to the two-piece characteristic of the abutment system according to the invention, whereat the prosthetic post can be separated from the abutment basis and thus the abutment basis can remain in the mouth. Therefore, the soft tissue adhesion is not destroyed.

Suitable as implants in all embodiments of the abutment system are implants with a base body that has a parallel wall or root-shaped (conical) configuration and has a rotationally symmetric shape relative to a central axis of rotation, which coincides with the implant axis. Currently, so-called screw implants (screw-type implants) are preferably used. Such screw implants—but other standard implants as well—can be used in connection with the present invention. The implant thereby serves as anchoring element in the jawbone.

In accordance with the invention, the abutment basis is seated such that the upper edge is positioned supracrestally. Preferably (but not exclusively) the upper edge of the abutment basis is positioned ≧1 mm above the bone ridge of the alveolus of the extracted tooth. An implantation method is particularly preferred where the upper edge is positioned circularly about 1.5 mm above the jawbone.

An element/component prefabricated in series serves as so-called abutment basis, which is employed as connecting element between the implant and a supra construction or crown. The abutment basis of the invention serves as intermediate element between the implant and the restoration, whereat the abutment basis is seated in the soft tissue region.

Due to the fact that an abutment basis is used that is prefabricated in series, a closed sterile chain can be guaranteed being essential for the invention.

In accordance with the invention, three or four different types/shapes of abutment basis can be provided in order to take into account the different shapes of anterior and premolar teeth.

The abutment basis of the invention can be produced in specialized production sites in highest quality, geometric stability and with endurable materials. The endurable materials can be picked taking into consideration the geometric stability and the body compatibility. A machining of the abutment basis is not required. Therefore, particularly titanium, titanium alloys and zircon oxide, or a combination thereof are suitable as material for the abutment basis.

The abutment basis preferably comprises, in all embodiments, a material chosen from the group of the metals, the metal alloys, ceramic materials and combinations thereof.

In accordance with the invention, at least one mass-produced and sterile packed abutment basis is employed, where a fitting insertion post is provided sterilely packed together with the abutment basis as well. The mentioned supra construction or crown, however, are in most cases produced individually per patient.

In accordance with the invention, the abutment basis can be connected to the implant for instance via a polygonal interface. Depending on the implementation the polygonal interface enables three or more than three angular positions (index positioning) of the abutment basis with respect to the implant. Thus, one gains additional degrees of freedom enabling an optimum alignment of the mass-produced, scalloped abutment basis relative to the bone and tissue structures.

The employment of an implant-abutment-restoration-unit (here altogether called implant system) in accordance with the invention provides aesthetically very appealing results, since, above all, in the marginal soft tissue no or only very small recessions are to be observed.

Gingival tissue structures and the contour thereof can be preserved as far as possible by the invention, what inter alia causes a fast incorporation and a stable anchoring.

Further advantageous embodiments can be taken from the dependent claims.

### DRAWINGS

Embodiments of the invention are going to be described in more detail in the following by making reference to the drawings.

FIG. 1A shows a schematic frontal view of two human anterior teeth including the surrounding gingiva;

FIG. 1B shows a strongly schematized sectional view in mesial direction of the right hand anterior tooth of FIG. 1A including the surrounding soft tissue morphology and bone morphology;

FIG. 1C shows a strongly schematized sectional view in palatine direction of the right hand anterior tooth of FIG. 1A including the surrounding soft tissue morphology and bone morphology;

FIG. 2A shows a strongly schematized sectional view of a premolar PM: 15 and a molar BZ: 16 of the upper jaw of a human denture including the surrounding soft tissue morphology viewed from below;

FIG. 2B shows a schematic view of a human upper jaw viewed from below;

FIG. 3A shows a strongly schematized perspective view of an implant system according to prior art comprising an implant with parallel walls and an abutment mounted thereon;

FIG. 3B shows a strongly schematized top view of the implant systems according to FIG. 3A;

FIG. 3C shows a strongly schematized side view of the implant systems according to FIG. 3A;

FIG. 4 shows a schematic side view of a one-piece, scalloped, rotationally symmetric dental prosthesis according to prior art;

FIG. 5A shows a side view of a first abutment basis of the invention in mesial direction (similar to the viewing direction in FIG. 1B), whereat the position and shape of a fitting exemplary implant is indicated by means of dashed contour lines;

FIG. 5B shows the same side view of the first abutment basis of FIG. 5A, whereat reference lines are drawn;

FIG. 5C shows a miniaturized side view of the first abutment basis of FIG. 5A together with a prosthetic post viewed in mesial direction;

FIG. 5D shows a side view of the first abutment basis of the invention viewed in palatine direction;

FIG. 6A shows a strongly schematized top view of a further abutment basis of the invention, which has a slightly deltoid foot print;

FIG. 6B shows a side view of a prosthetic post for attaching to an abutment basis according to the invention;

FIG. 6C shows a side view rotated by 90 degrees of the prosthetic post of FIG. 6B;

FIG. 6D shows a side view of an insertion post for attaching to an abutment basis according to the invention;

FIG. 6E shows a side view rotated by 90 degrees of the insertion post of FIG. 6D;

FIG. 6F shows a side view of a further insertion post for attaching to an abutment basis according to the invention;

FIG. 6G shows a section though the upper section of the insertion post of FIG. 6F;

FIG. 7 shows a strongly schematized perspective view of an exemplary implant in accordance with the prior art, which can be used in connection with the present invention;

FIG. 8 shows a strongly schematized side view of typical shapes and sizes of teeth viewed from below (foot print);

FIG. 9 shows a strongly schematized view of the foot print of four typical shapes and sizes of abutments;

FIG. 10A shows a strongly schematized top view of a further abutment basis of the invention, which has an oval foot print;

FIG. 10B shows a strongly schematized perspective view of a crown, which is constructed for attaching to an abutment basis of FIG. 10A;

FIG. 11 shows a side view of an abutment system according to the invention, which comprises a insertion post and an abutment basis, where the two are sterilely packed together in a housing;

FIG. 12 shows a side view of a further insertion post for inserting an abutment basis according to the invention;

FIG. 13 shows a side view of a further insertion post for inserting an abutment basis according to the invention;

FIG. 14 shows a side view of a further abutment basis according to the invention viewed in mesial direction (similar to the viewing direction in FIG. 5A).

### DETAILED DESCRIPTION

Terms are used in conjunction with the present description that are also used in relevant publications and patents. However, it is to be noted that the use of these terms is only to serve for better understanding. The ideas of the invention and the scope of protection of the patent claims are not to be restricted in the interpretation thereof by the specific selection of the terms. The invention may readily be transferred to other term systems and/or technical fields. The terms are to be applied accordingly in other technical fields.

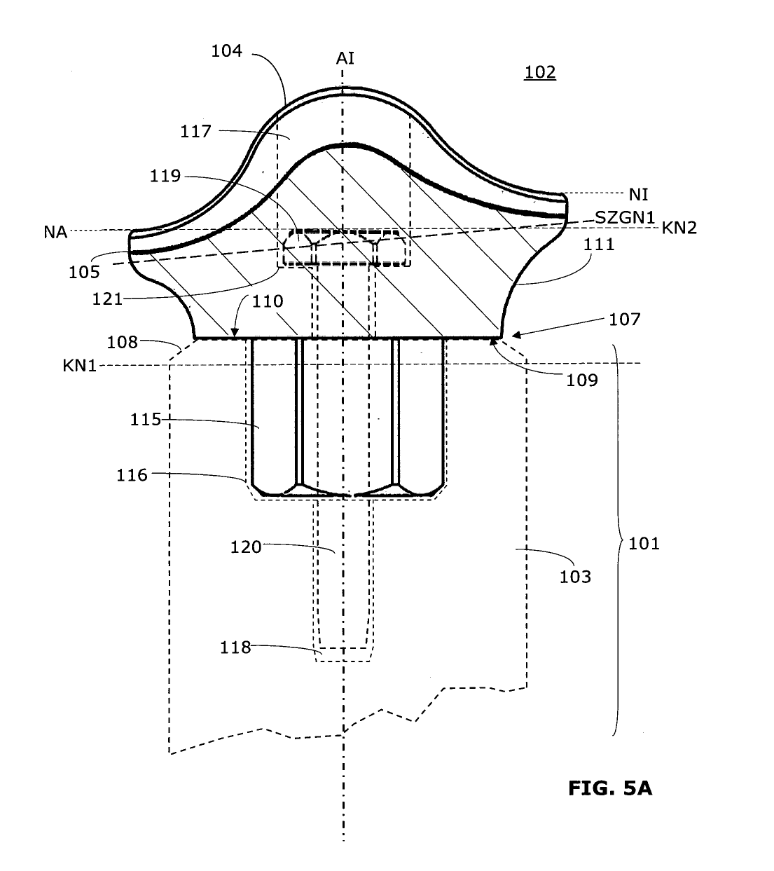

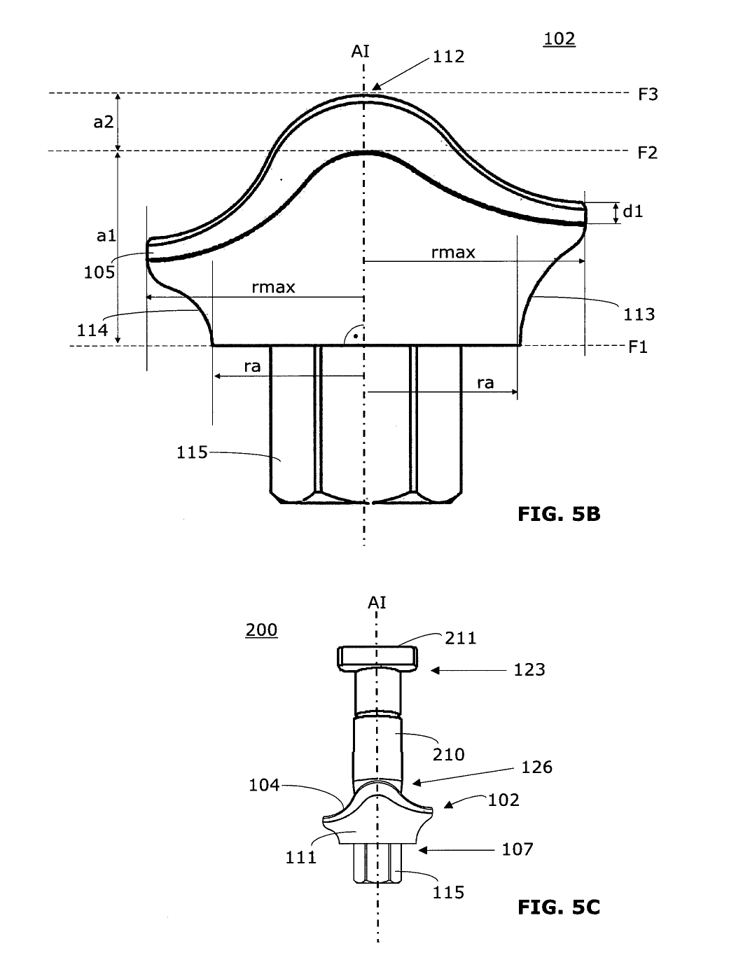

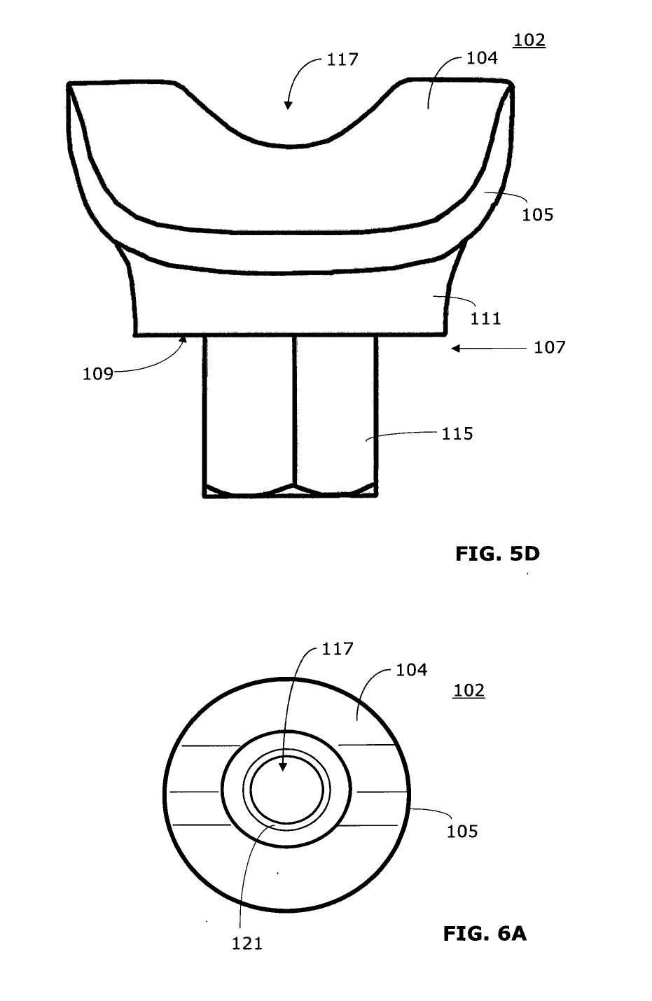

In accordance with the invention, an abutment system 200 (see for instance FIG. 5C) is concerned that is primarily designed for use in the region of the anterior and premolar teeth. The abutment system 200 comprises an abutment basis 102. An exemplary abutment basis 102 is shown in the FIGS. 5A through 5D. The abutment basis 102 comprises a first interface 107, which is designed for the attachment on an implant 103, as indicated in FIG. 5A, for instance. After the insertion, the implant 103 defines, by the position of its implant axis AI, the position of all further elements (such as abutment basis 102, insertion post 130 and restoration elements), which are fixed at or on the implant 103, as indicated in FIG. 5C. The abutment system 200 comprises a second interface 123 in addition to the first interface 107 for the attachment of the restoration elements (e.g. a crown or supra construction).

The insertion post 130 and the prosthetic post 210 are both referred to as post herein.

The abutment basis 102 has, in all embodiments of the invention, a scalloped upper surface 104 and has a three-dimensional shape, which is not designed symmetrically with respect to the implant axis AI. Furthermore, the abutment basis 102 is enclosed by a lateral area 111, which has a concave form viewed in the vertical section. This concave form of the lateral area 111 can be seen well in the FIGS. 5A and 5B, for instance.

The abutment system 200 has, in all embodiments, in addition a separate prosthetic post 210, which can be attached in the region of the scalloped upper surface 104 of the abutment basis 102 such that the prosthetic post 210 in the fixed state extends coaxially with respect to the implant axis AI. An exemplary abutment system 200 with abutment basis 102 and prosthetic post 210 is shown in FIG. 5C.

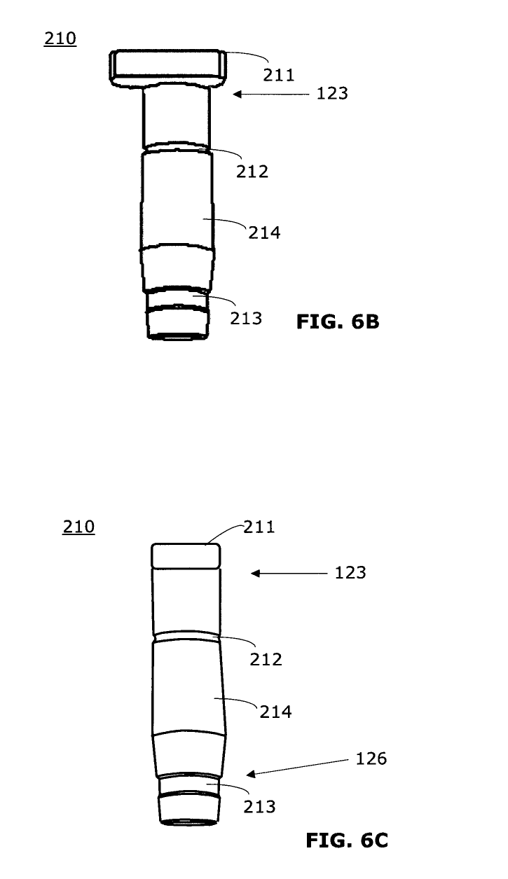

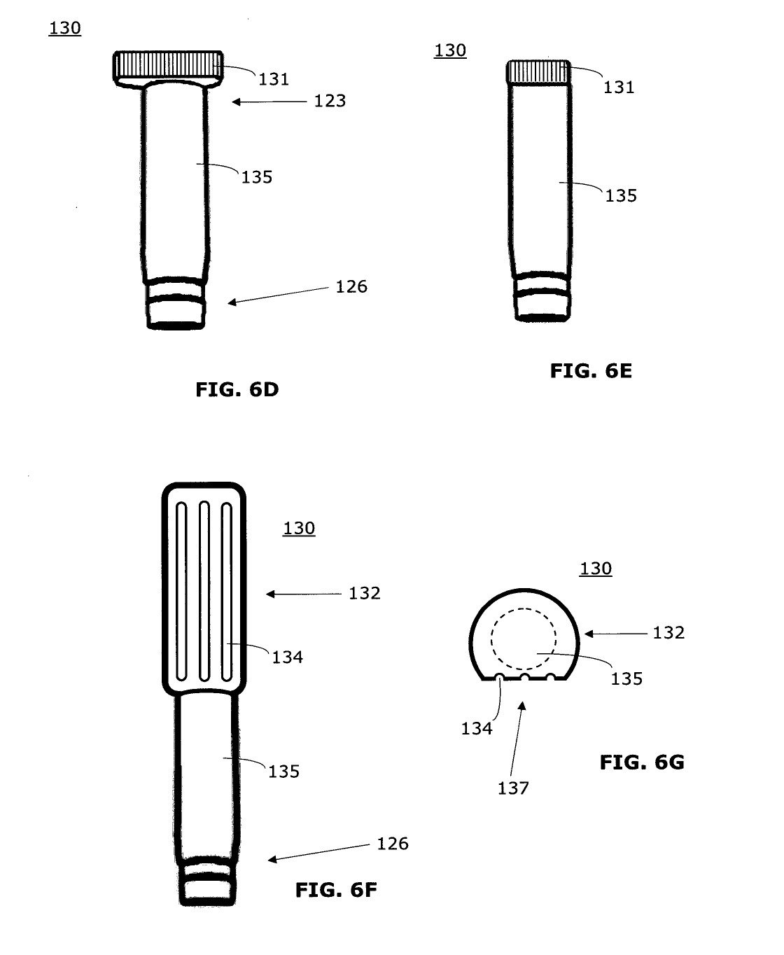

Preferably in all embodiments, the abutment basis 102 comprises a proximal interface plane 109 in the region of the first interface 107, which is essentially flat and stands perpendicularly with respect to the implant axis AI. Furthermore, preferably in all embodiments, the abutment basis 102 comprises a through hole 117 in the region of the scalloped upper surface 104 that serves for the attachment of the prosthetic post 210 and/or for connecting it with the implant 103. The position of the through hole 117 can be seen in FIG. 5D in outlines. The through hole 117 of another abutment basis 102 according to the invention is shown in FIG. 6A in a top view.

In accordance with the invention the cross-sectional shape (in the vertical section through the abutment basis 102) is asymmetrical, as is presented in the following.

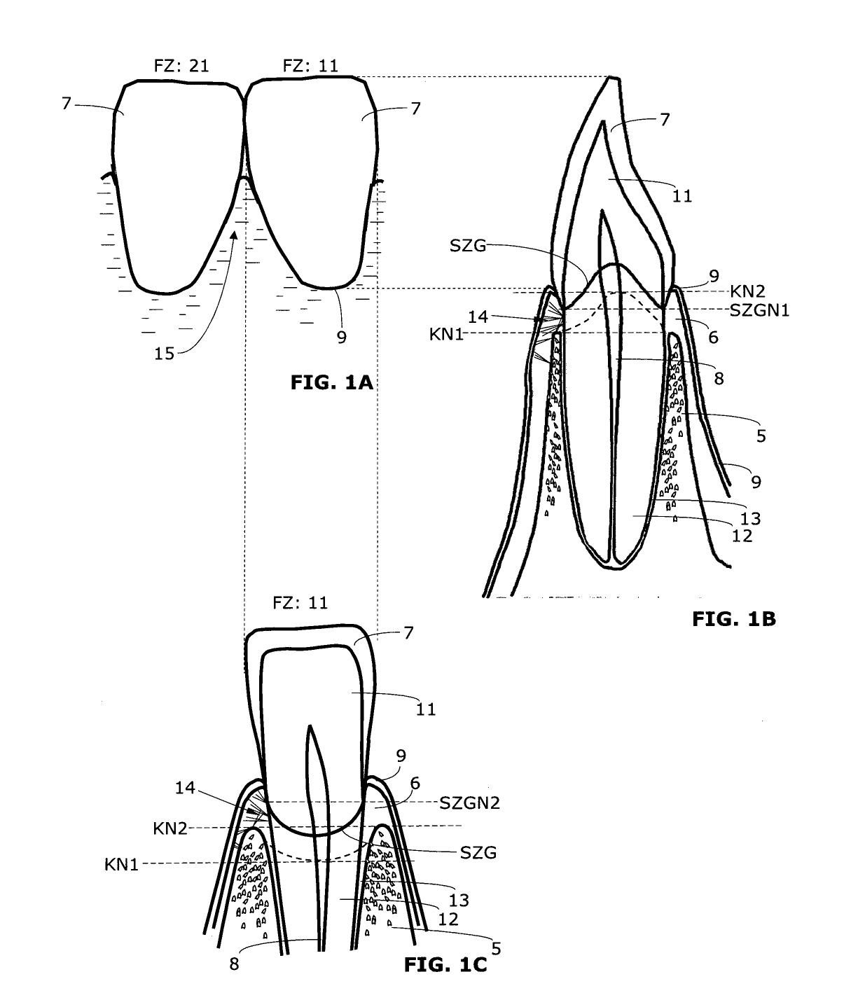

In case of an anterior tooth FZ, for instance, the cemento-enamel junction SZGN2 on the right hand and left hand side (i.e. interdental) of the tooth FZ: 11 can lie at about the same height, as indicated in FIG. 1C. The progression of the cemento-enamel junction SZG follows at the front of the tooth (on the left in FIG. 1B) and the rear side of the tooth (on the right in FIG. 1B) more or less the curved contour of the gingiva 9, which forms a collar around the tooth. The progression of the cemento-enamel junction SZG is depicted in FIG. 1B by a curve that is bulged upwards. The progression of the bone level is illustrated in dashed form in the side view of FIG. 1B by a further curve that is bulged upwards, whereat the maximum of this curve is denoted as bone level KN2. The progression of the cemento-enamel junction SZG is depicted in FIG. 1C by a curve that is bulged downwards. The progression of the bone level is illustrated in dashed form in the view of FIG. 1C by a further curve that is bulged downwards, whereat the minimum of this curve is denoted as bone level KN1. For the sake of a simplified presentation, in case of the schematic illustration of FIG. 1B the level of the cemento-enamel junction SZGN1 at the front- and rear side of the tooth FZ: 11 are at the same height. I.e., the line that reproduces the level of the cemento-enamel junction SZGN1 is running horizontally here. However, the level of the cemento-enamel junction SZGN1 and the contour of the gingiva 9 are typically lying at a different height at the front of a tooth and at the rear side of a tooth, i.e., the line that reproduces the level of the cemento-enamel junction SZGN1 is mostly inclined in practice. The inclined progression of the level of the cemento-enamel junction SZGN1 is exemplarily depicted in FIG. 5A by means of a dashed reference line. Correspondingly, the level NA (A stands for outside=vestibular) differs from the level NI (I stands for inside=oral) at the abutment basis 102 of the invention, as can be seen in Fig, 5A. Hence, an asymmetry of the shape of the cross section and a specially directed orientation (angular positon) result, which have to be observed when fixing the abutment bass 102 on the implant 103.

The asymmetry of the shape of the cross section can be recognized in FIG. 5A on the basis of the first abutment 102, where it is to be mentioned that FIG. 5A does not show a cross section but a side view. The abutment basis 102 is shown in FIGS. 5A through 5C with the same orientation as the tooth FZ: 11 in FIG. 1B.

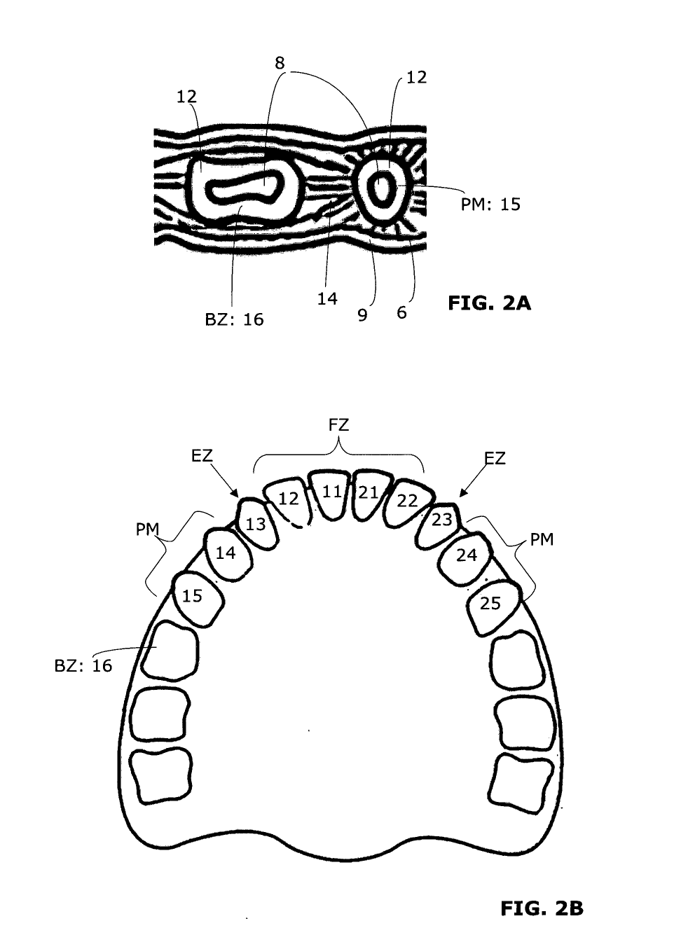

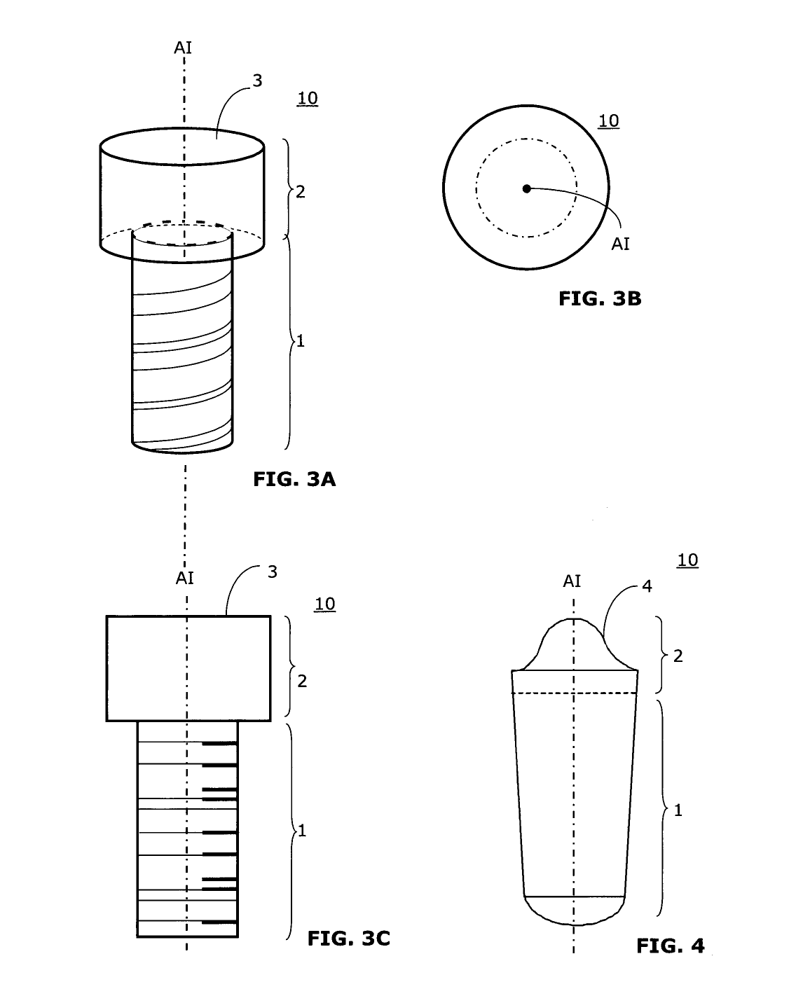

It can be recognized in FIG. 2B in outlines that each tooth has another typical cross section and/or foot print. The premolars PM (e.g. the teeth PM:14 and PM:15 pursuant to the FDI-scheme) typically have an oval cross section (for instance like the shape of the foot print Q1 in FIG. 8), the canine teeth EZ (e.g. the tooth EZ: 13 pursuant to the FDI-scheme) typically have a deltoid cross section with rounded corners (for instance like the shape of the foot print Q2 in FIG. 8) and the anterior teeth (e.g. the teeth FZ:11 and FZ:12 pursuant to the FDI-scheme) typically also have a deltoid cross section with rounded corners (for instance like the shape of the foot prints Q3 and Q4 in FIG. 8).

Investigations have revealed that the variety of shapes and the variations in relation to difference of shape and dimension in case of anterior and premolar teeth is really very small. In accordance with the invention, it is thus possible to offer three or four industrially produced abutment basis 102 (as indicated in FIG. 9) in order to be able to create a substitute for a human anterior tooth FZ or premolar PM for almost every case.

The respective abutment basis 102 of the invention have approximately, if viewed from the top, the contour and dimension of the cemento-enamel junction SZG of the corresponding shapes Q1, Q2, Q3, and Q4, as schematically illustrated in FIG. 8. Four possible shapes of foot prints and dimensions (projected into the plane of the drawing) of the abutment basis 102 are schematically shown and designated as E1 through E4 in FIG. 9. The shape of foot print E1 has an oval or slightly ovoid shape. An abutment basis 102 pursuant to the shape of foot print E1 preferably has a dimension of 4.5 mm times 6 mm and is suitable for making a dental prosthesis of a premolar. The shape of foot prints E2, E3, and E4 have deltoid shapes. An abutment basis 102 pursuant to the shape of foot print E2 preferably has a diameter of 4 mm, an abutment basis 102 pursuant to the shape of foot print E3 preferably has a diameter of 5 mm and an abutment basis 102 pursuant to the shape of foot print E4 preferably has a diameter of 6 mm. The shapes of foot prints E2, E3, and E4 are especially suitable for making a dental prosthesis of a canine or anterior tooth. The circumferential ridge/shoulder 105 defines the shapes of the foot prints E2, E3, and E4 if viewed from above or in the projection into the plane of the drawing. None of the shapes of foot prints E1-E4 is rotationally symmetric with respect to the implant axis A1, which in FIG. 9 stands perpendicular on the plane of the drawing.

It can be determined, for instance, by means of a local examination of the extraction channel and/or the extracted tooth and/or by means of imaging methods, which type and which size of the abutment basis 102 according to the invention is suitable in order to build up a dental prosthesis. When choosing the type and size of the abutment basis 102 the position and thickness of the connective tissues 6 above the jawbone 5 (if viewed from crestal direction) is preferably determined (see FIG. 1B and FIG. 1C) too. In this context values for the thickness and/or the position of the mesial (in the direction of the jaw centre line), distal (remote from the jaw centre line), vestibular (towards the outside) and palatial (pointing towards the palatine) connective tissue 6 can be considered.

The invention does not focus on abutment basis produced individually for patients but on ready-made abutment basis 102. In order to enable optimum solutions nonetheless, preferably in all embodiments, an implant system 100 comprises different (preferably at least three) abutment basis 102 with the shapes E1, E2, E3, and E4 (see FIG. 9) so that the surgeon in each case has a suitable abutment basis 102 at hand, the shape and size of which approximately corresponds to the local situation after the extraction of a tooth.

Preferably in all embodiments, such an implant system 100 comprises at least one abutment basis 102 that has an elliptic shape of the foot print similar to E1 viewed in a horizontal section, an abutment basis 102, and at least one roundish-deltoid shape of the foot print similar to E2 and/or E3 and/or E4.

In doing so, the shapes of the foot prints E1-E4 of the abutment basis 102 are adapted to the shapes of the foot prints Q1-Q4 of an anterior tooth FZ, canine tooth EZ or premolar tooth PM to be replaced by a dental prosthesis 100.

An abutment basis 102 of the invention comprises, if viewed from the bottom to the top, at least the following characteristic in all embodiments:
A first interface 107; preferably there is a proximal interface plane 109, which in the mounted state runs parallel (plane on plane) with respect to a distal surface 110 of the implant 103. The interface plane 109 lies perpendicular with respect to the implant axis AI and is essentially planar. Preferably, there also is a connecting post for an inner or outer implant connection 115, as is exemplarily and schematically shown in FIG. 5A.
A concave lateral area 111, which provides for a harmonic (free of edges) transition from the interface plane 109 to a circumferential ridge/shoulder 105. The face of the lateral area 111 is hatched in FIG. 5A in order to visually highlight it.
A circumferential ridge/shoulder 105, which in the projection into a plane that is perpendicular to the drawing plane of FIG. 5A, corresponds to or approximates one of the shapes of the foot prints E1, E2, E3 or E4 of FIG. 9. In an interdental side view the circumferential ridge/shoulder 105 has the scalloped progression shown in FIG. 5A, whereat the level NA (A stands for outside) can be different from the level NI (I stand for inside). On the palatine and/or vestibular side, the circumferential ridge/shoulder 105 has a curve shape which is bulged downwards, as can be seen in FIG. 5D. Preferably in all embodiments, the soft tissue contact area of the circumferential ridge/shoulder 105 is smooth.
A distal, scalloped surface 104, which, in the projection into a plane that is perpendicular with respect to the drawing plane of FIG. 5A, corresponds to or approximates one of the shapes of the foot prints E1, E2, E3 or E4 of FIG. 9.

Reference lines and information can be seen in FIG. 5B, which permit to better describe the shape and dimension of the abutment basis 102. The interface plane 109 lies in a plane F1 that is perpendicular with respect to the implant axis AI. Preferably in all embodiments, the distance a1 (in parallel to the implant axis AI) between the plane F1 and the plane F2 is between 2 mm and 8 mm depending on the abutment basis 102. Preferably in all embodiments, the distance a2 (in parallel to the implant axis AI) between the plane F2 and the plane F3 is between 0.3 mm and 5 mm depending on the abutment basis 102. The circumferential ridge/shoulder 105 preferably has a thickness d1 (in parallel to the implant axis AI) in the palatine and vestibular region of the abutment 102, which is between 0.1 mm and 0.6 mm. The thickness of the circumferential ridge/shoulder 105 in the region of the apex 112 of the abutment basis 102 corresponds to the mentioned distance a2.

Preferably in all embodiments, the radial axial distance ra between the implant axis AI and the outermost circumference of the interface plane 109 is between 1.5 mm and 3 mm. It is to be observed that the interface plane 109 is preferably designed circularly and concentric with respect to the implant axis AI in all embodiments.

Preferably in all embodiments, the maximum radial distance rmax between the implant axis AI and the outer circumference of the ridge/shoulder 105 is between 2 mm and 5 mm. It is to be observed that the implant axis AI preferably lies in the centre of the ovoid or deltoid shapes E1, E2, E3, E4.

Preferably, all abutment basis 102 of the invention have a total height a1+a2, which is 10 mm at most. Typically the total height a1+a2 is even smaller than 6 mm.

Preferably, the abutment basis 102 of the invention have a maximum diameter, which is 10 mm at most. Typically the maximum diameter is smaller than 6 mm.

The described concave lateral area 111 provides for a smooth (i.e. free of steps) transition between the rotationally symmetric interface plane 109 and the non-symmetric circumferential ridge/shoulder 105 or the non-symmetric scalloped surface 104 in all embodiments.

One can see in the side view of FIGS. 5A and 5B that the cross section is designed asymmetrically with respect to the implant axis AI, i.e., the respective part of the abutment basis 102, which lies on the right hand side of the implant axis AI, does not have a mirror symmetry with respect to that part of the abutment basis 102 that lies on the left hand side of the implant axis AI. The concavity on the vestibular side (curve 114) and the concavity on the palatine side (curve 113) are considerably distinct.

The apex 112 of the abutment basis 102 of the invention does not have to lie on the implant axis AI in all embodiments, as is the case in the example that is shown in FIGS. 5A and 5B.

FIG. 5C shows a miniaturized side view of the first abutment basis 102 of FIG. 5A together with a prosthetic post 210 placed on top, which is coaxially connected (e.g. screwed on) to the abutment basis 102 with respect to the implant axis AI. The prosthetic post 210 comprises an interface (here called second interface 123), which serves for attaching/fixing a crown 122 or a supra construction. A head or a plate 211 can for instance be provided at the prosthetic post 210, as can be seen in FIGS. 5C, 6B, and 6D. In FIG. 6B it can be seen that the head or the plate 211 protrudes beyond the diameter of the prosthetic post 210. The head or the plate 211 can be designed asymmetrically with respect to the shaft 214 in all embodiments, as can be seen in FIG. 6B. The head or the plate 211 can be flattened on the side, as can be seen in FIG. 6C, and/or the shaft 214 can be flattened. Circumferential notches 212, 213 can be provided at the prosthetic post 210, as shown.

An exemplary insertion post 130 is shown in FIG. 6D. The insertion post 130 can comprise, for example, a head or the plate 131, which head or plate may protrude beyond the diameter of the insertion post 130. Preferably in all embodiments, the head or the plate 131 are asymmetrically arranged with respect to the rotationally symmetric shaft 135 of the insertion post 130, as shown in FIG. 6D. The head or the plate 131 may be flattened, on the side as shown in FIG. 6E. Ripples can be provided in the region of the head or the plate 131 of the insertion post 130 in order to improve gripping or rotating the insertion post 130.

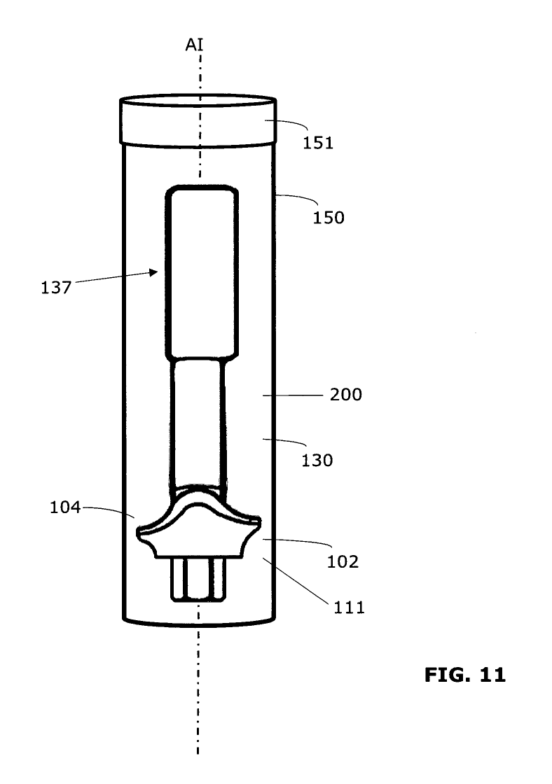

In FIG. 6F a side view of a further insertion post 130 for attaching an abutment basis 102 according to the invention is shown. The herein shown insertion post 130 has an extending head region or handle region 132 enabling a safe attachment of the insertion post 130. FIG. 6G shows a section through the upper section of the insertion post 130 according to FIG. 6F. The extending head region or handle region 132 can be flattened on the side, as shown in FIG. 6G. The corresponding incline is designated with the reference number 137 in FIG. 6G. The incline 137 of FIG. 11 shows to the left side. Ripples 134 can be provided in the region of the head region or the handle region 132 of the insertion post 130 in order to to improve gripping or rotating the insertion post 130.

The insertion post 130 of FIGS. 6D and 6E and the insertion post 130 of FIG. 6F can be attached to the abutment basis 102 similar to the post 210 of FIG. 5C.

The abutment basis 102 is inserted into the implant by means of a insertion post 130. This insertion post 130 is linked to the abutment basis 102 by the interface 123. The insertion post 130 is designed such that its flattened side is oriented based on the vestibular region of the abutment basis 102. The insertion post 130 facilitates the three-dimensional positioning of the asymmetric abutment basis 102 and prevents a contamination of the contact area in the cladding are 111 during insertion.

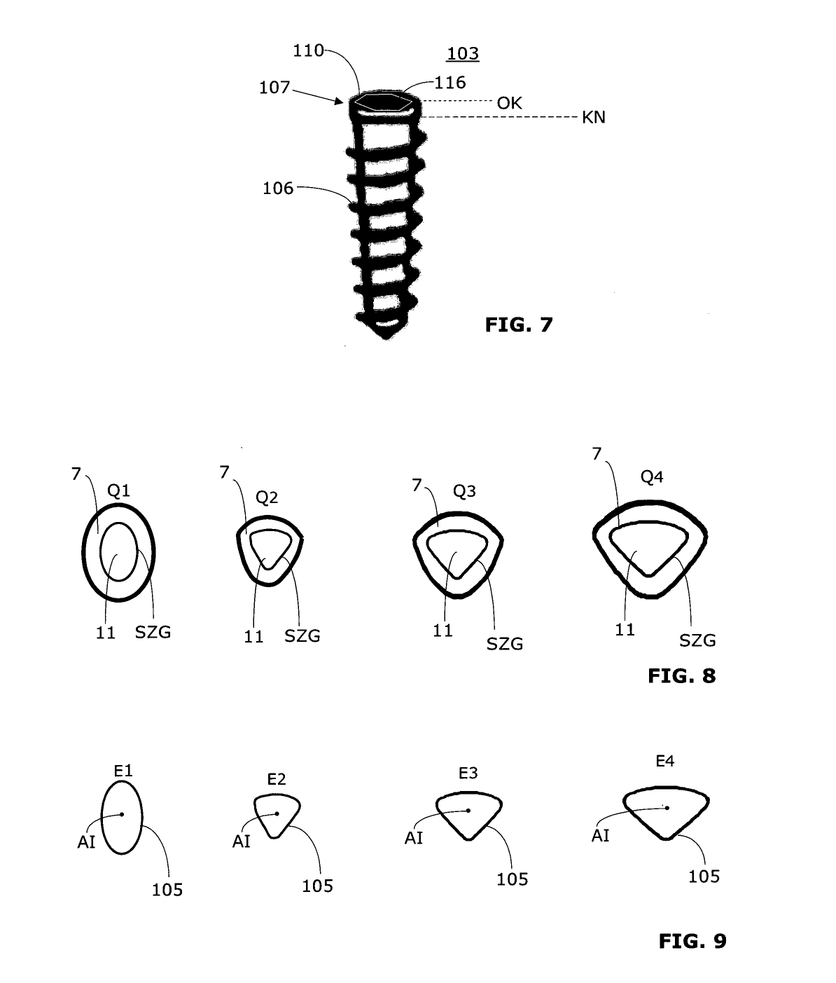

Preferably, all embodiments of the abutment basis 102 comprise a connecting post for an internal or a receiving opening for an external implant connection 115, which can be seen in FIGS. 5A, 5B, 5C, and 5D. The connecting post can be polygonal and/or conical having a rotational symmetry. This connecting post 115 or the receiving opening serves as interface with the implant 103. If such a connecting post 115 is provided at the abutment basis 102, the implant 103 comprises a corresponding, appropriately designed receiving opening 116 (internal connection). In FIG. 7 this receiving opening 116 is purely schematically indicated by a black hexagon. In FIG. 5A this receiving opening 116 is shown by a dashed line.

There are already many different (standard) interfaces 107 in order to enable an abutment basis 102 to be connected with an implant 103. Most of the interfaces employed today are designated, depending on the constellation, internal hex-interface (as shown in FIGS. 5A, 5B, and 6A), external hex-interface, standard hex-interface, slim hex-interface, wide hex-interface and so on.

Established interfaces are for instance known from the documents U.S. Pat. No. 4,960,381, U.S. Pat. No. 5,407,359, U.S. Pat. No. 5,209,666, and U.S. Pat. No. 5,110,292. These prior known solutions can be used in connection with all embodiments of the present invention.

After having chosen a suitable abutment 102, this abutment is connected to the implant 103 such that the circumferential ridge/edge 105, which runs asymmetrically around the abutment 102 and, to the extent possible, has about the same distance in all directions (mesial, distal, vestibular and palatine) with respect to the jawbone 105, and an even position with respect to the connective tissue 6.

Preferably in all embodiments, the abutment basis 102 have a pronounced circumferential ridge/shoulder 105, as can be seen in FIG. 5A, for instance. The circumferential ridge/shoulder 105 approximately follows the area of the largest diameter/circumference of the abutment basis 102 viewed in the horizontal.

The abutment basis 102 of the invention is approximately approximated to the asymmetric scalloped shape and progression of the cemento-enamel junction SZG. Thus, the abutment basis 102 also has an asymmetric scalloped shape and the abutment basis 102 is connected to the implant 103 such that the orientation of the scalloped surface 104 of the abutment basis 102 essentially corresponds to the position of the cemento-enamel junction SZG of the tooth prior to the extraction. For this reason the angular position (index positioning) of the abutment basis 102 with respect to the implant 103 is important. The (hex-) interface 107 thus plays an important role since it enables a rotation of the abutment basis 102 about the implant axis AI relative to the fixedly implanted implant 103. The insertion of the asymmetric abutment basis 102 is facilitated by means of an insertion post 130. This insertion post 130 is preferably pre-mounted on the abutment basis 102 such that its flattened side 130 is oriented based on the vestibular region 114 of the abutment basis 102.

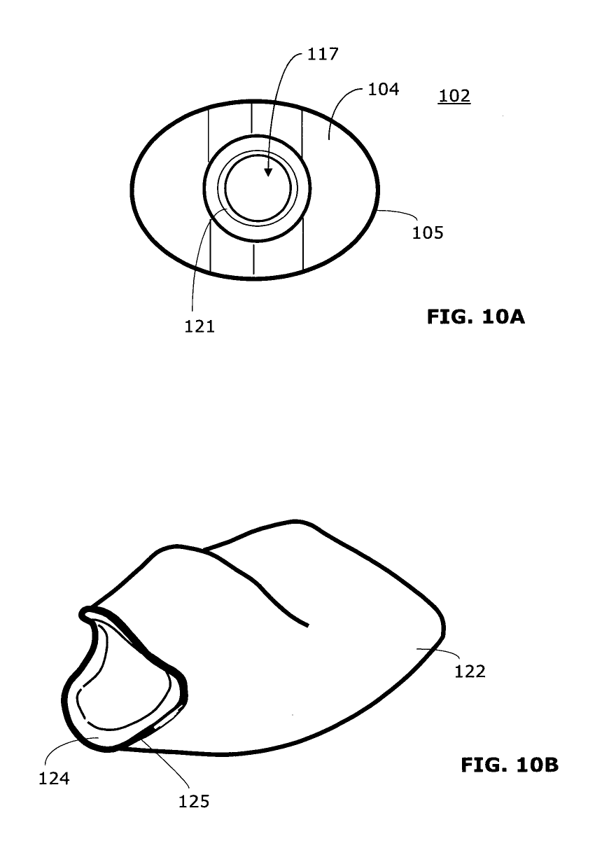

After the abutment basis 102 was placed on the implant 103 in the right angular position (index position) and connected therewith (e.g. by means of a set screw or a screw 120, as shown in FIG. 5A), a temporary crown can be fixed on the abutment basis 102 e.g. using a known glue or cement, until a final crown 122 (see FIG. 10B) is available. Preferably, the mentioned prosthetic post 210 is employed for fixing the crown 122 or a supra construction. These steps are sufficiently known and are thus not explained further.

In order to enable the connecting of the abutment basis 102 with the implant 103, the abutment basis 102 preferably comprises a through hole 117 and the implant 103 a screw hole 118 with internal thread, as schematically illustrated in FIG. 5A by means of an example. The through hole 117 and the screw hole 118 extend coaxially with respect to the implant axis AI. This way, a set screw or a screw 120 can be screwed in from above into the screw hole 118 in order to fix the abutment 102 on the implant 103. The through hole 117 preferably has a collar or a reduction of the diameter 121 lying inside so that a head 119 of the screw 120 can rest thereon. This kind of connection of the abutment basis 102 with the implant 103 can be used in all embodiments. However, there are also other approaches that can be used. It is important that the prosthetic post 210 can be inserted into the abutment basis 102 from above and fixed there.

In case of correspondingly designed implant systems 100 the through hole 117 can be seen in a top view of the scalloped surface 104 of the abutment basis 102, as shown in FIGS. 6A and 10A. Depending on the orientation, the through hole 117 can also be seen in a side view of the abutment basis 102 (see FIG. 5D).

In FIG. 6A a top view of an abutment basis 102 having a slightly deltoid shape is shown. In the top view the through hole 117 as well as the collar or a reduction of the diameter 121 can be seen. In FIG. 10A, however, the top view of an abutment basis 102 is shown, which has an ovoid shape. In the top view the through hole 117 as well as the collar or a reduction of the diameter 121 can be seen.

Preferably, the implant system 100 according to the invention, which comprises at least one abutment basis 102, the (standard-) implant 103 and the insertion post 130, is implanted a short time after the extraction of a tooth (e.g. an anterior tooth FZ) in order not to permanently “disturb” the surrounding tissue- and bone structures. In this context care is taken that, contrary to the doctrine, the unit of implant 103 and abutment basis 102 is fixed in the bone so that the scalloped surface 104 of the abutment basis 102 is lying supracrestally at approximately 1.5 mm. An exemplary standard implant 103 with a conically shaped base body is shown in FIG. 7, whereat the implant 103 comprises an outer thread and a mechanical interface 107 for connection with the abutment basis 102 of the invention.

The implant 103 can either have parallel walls or a conical (root shaped) base body in all embodiments. In FIG. 5A an implant 103 with a parallel wall base body in indicated by means of dashed lines. In FIG. 7, however, an implant 103 with a conical base body is schematically illustrated. The type/shape of the implant 103 is to be suitably considered when providing the required drill holes in the jawbone 5.

One can also temporarily screw on/clip on an impression post on the abutment basis 102, which, in the broadest sense, corresponds to the negative occlusal surface profile of the abutment (profile in the top view) inside the patient's mouth. However, the prosthetic post can also serve as impression post. It is important that the seat of the impression post is precisely defined with respect to the abutment basis 102 in the three-dimensional observation.

The abutment basis 102 comprises, in all embodiments, a biocompatible material, preferably titanium, a titanium alloy or zirconium oxide, or a combination thereof, and it can, if desired, be coated with titanium-zirconium ceramic and/or titanium-niobium-oxide nitride ceramic, for example. The soft tissue contact area of the lateral area 111 can partially or completely be polished, machined, plasma-treated, blasted, etched, laser-treated or coated with bio-active material, or can comprise a combination thereof. It is important that the soft tissue contact area of the lateral area 111 has a hydrophilic or ultra-hydrophilic characteristic in order to achieve a soft tissue adhesion.

In order to achieve a hydrophilic or ultra-hydrophilic area, the soft tissue contact area of the concave lateral area 111 is, for example, fully hydroxylated by hydroxide groups. These hydroxide groups can be generated by electrolytic or chemical acid etching of the concave lateral area 111. The hydroxide groups are located in the most outer layer of the surface of the concave lateral area 111 of the abutment basis 102.

In order to achieve the hydrophilic or ultra-hydrophilic characteristic of the soft tissue contact area of the lateral area 111, the abutment basis 102 together with the insertion post 130 can be delivered/stored in liquids or gases in a container 150, which is impermeable to gases and liquids. The container 150 at its inner surface consists of a material that does not change the hydrophilic or ultra-hydrophilic characteristic of the soft tissue contact area of the abutment basis 102. Containers 150 made of glass or acrylic glass are particularly suitable.

The concave lateral area 111 of the abutment basis 102 preferably comprise a smooth and/or micro-rough section 127 in all embodiments.

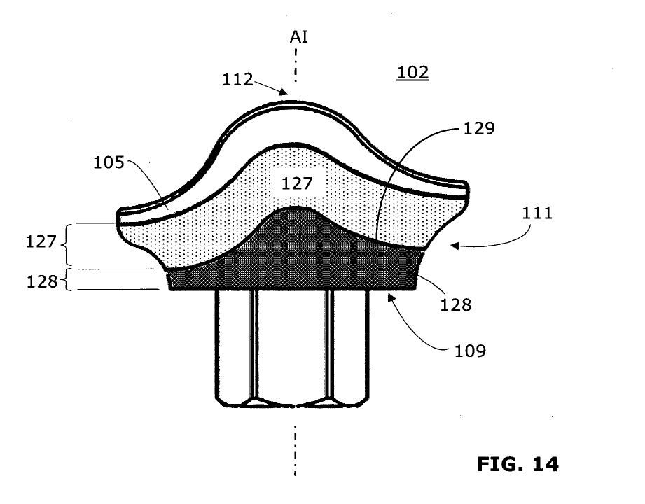

An exemplary schematic illustration of an abutment basis 102 is shown in FIG. 14, whereat the concave lateral area 111 of the abutment basis 102 has a micro-rough section 128 (illustrated by a darker filling) and a smooth section 127 (illustrated by a lighter filling). All embodiments that have a smooth section 127 and a micro-rough section 128 have a separation line 129 in the lateral area 111. This separation line 129 defines the transition between the connective tissue (micro-rough) section 128 and the epithelium (smooth) section 127 of the soft tissue contact area. This separation line 129 preferably has a scalloped shape in all embodiments, as shown in FIG. 14. This separation line 129 preferably follows the scallop of the circumferential shoulder 105 and thus has an asymmetrical progression in all embodiments.

The micro-rough section 128, if present, is, in all embodiments, preferably arranged in that region of the lateral area 111 the connective tissue shall lie next to after attaching the abutment basis 102.

The smooth section 127, if present, is preferably arranged in the region between the micro-rough section 128, if present, and the circumferential shoulder 105 of the abutment basis 102 in all embodiments, as shown in FIG. 14.

The micro-rough section 128 and the smooth section 127, if both are present, preferably extend around the implant axis AI annularly in all embodiments, whereat the separation line 129 between the micro-rough section 128 and the smooth section 127 is scalloped.

The micro-rough section 128, if present, is preferably produced by a combination of sand blasting or corundum blasting and acid etching of a titanium surface of the concave lateral area 111 in all embodiments, where, for instance, the SLA® method of the company Straumann can be applied, which method was developed for the surface treatment of implant posts. A detailed description is given, e.g., in the European letters patent EP0388576 B1.

Preferably, the smooth section 127, if present, is produced by electro-polishing of the surface and by subsequent acid etching.

The terms micro-rough and smooth refer to the macroscopic quality of the surface.

Preferably in all embodiments, the hydrophilic or ultra-hydrophilic characteristic of the soft tissue contact area in the lateral area 111 are caused by nanostructures that are produced by a local surface treatment. These nanostructures improve the adhesion of the proteins during the wound healing.

One can apply the OsseoSpeed™ method of the company Astra Tech AB in order to generate the hydrophilic or ultra-hydrophilic characteristic in all embodiments. A detailed description is given, e.g., in the European patent application EP 2022447 A1.

Preferably in all embodiments, an implant 103 is employed that has a chamfered edge 108 in the region of the interface 107, which runs around 360 degrees. An implant 103 with chamfer 108 on the distal upper side 110 is indicated in FIG. 5A. The upper side 110 of the implant 103 is not completely flat in these cases.

An implant system 100 with such an implant 103 with chamfer 108 and one or more abutment basis 102 and with an insertion post 130 is particularly advantageous over hitherto existing implant solutions, especially because an overall waisted constellation results due to of the chamfer 108 and the special concave shaped lateral area 111.

A strongly schematized top view of a further abutment basis 102 of the invention, which here has an oval foot print, is shown in FIG. 10A. FIG. 10B shows a schematic perspective view of a crown 122 that is designed for attaching it on the abutment basis 102 of FIG. 10A. The crown 122 is lying with the front side of the tooth (tooth front) on a support in FIG. 10B. The rear side of the crown 122 is visible in FIG. 10B. One can recognize that the crown 122 comprises a complementary inner shape 124 that is exactly adapted to the shape and dimension of the abutment basis 102 of FIG. 10A. The crown 122 has a circumferential border 125 that approximately corresponds to the circumferential ridge/shoulder 105 of the abutment basis 102. The scalloped surface 104 of the abutment basis 102 sits inside the crown 122 when fixing the crown 122 on the abutment basis 102 and the circumferential border 125 sits tight on the circumferential ridge/shoulder 105 of the abutment basis 102.

According to the invention, the abutment basis 102 must not be reworked (e.g. grinded or polished) before implanting or inserting, since the sterile surface can be destroyed and the hydrophilic or ultra-hydrophilic contact area can be damaged by a reworking.

Abutment basis 102 that have been intraoperatively in contact with body liquids or have been contaminated must not be reused.

Neither strong alkaline cleaning agents or disinfectant nor other solutions shall be applied to the abutment basis 102, since these substances chemically attack the surface and may eventually be lead to the disintegration/destruction of the hydrophilic or ultra-hydrophilic surface.

Preferably, only brand new, sterile packed abutment basis 102 shall always be used.

FIG. 11 shows a side view of an abutment system 200 according to the invention, which comprises an insertion post 130 and an abutment basis 102, where the two are sterilely packed in a housing 150 together. The housing 150 can, e.g., comprise a tight sealing lid or plug 151 and it can be filled with a liquid (preferably water or a gel) or an inert gas, in order to protect the hydrophilic or ultra-hydrophilic surface. In the embodiment of FIG. 11, the vestibular side of the insertion post 130 is preferably also flattened (incline 137), as shown in FIG. 6G.

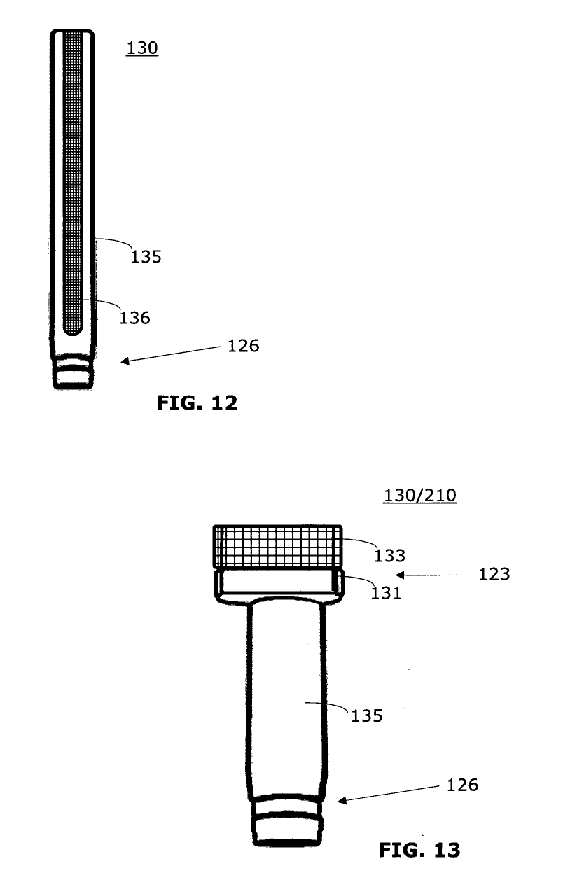

FIG. 12 shows a side view of a further insertion post 130 according to the invention. This insertion post 130 is essentially designed cylindric or conic and does not show an extension of circumference at the upper end region. In the embodiment according to FIG. 12, the vestibular side of the insertion post 130 is preferably also flattened. In FIG. 12 the corresponding incline is designated with the reference number 136.

In order to enable a better griping and rotating around the rotation axis of such an insertion post 130, the surface is preferably provided with a ripping at least in the region of the incline 136, as indicated in FIG. 12.

FIG. 13 shows a side view of a further insertion post 130 according to the invention. The insertion post 130 has an enlarged head region. Similar to FIG. 6D, the insertion post 130 of FIG. 13 shows a head or plate 131. The head or plate 131 is preferably designed asymmetrical with respect to the rotationally symmetric shaft 135 of the insertion post 130, as shown in FIG. 13. This head or this plate 131 is designed such that the insertion post 130 can also serve as prosthetic post 210. In order to facilitate a better griping of the insertion post 130 during attaching the abutment basis 102, the head or the plate 131 was extended by a top 133. This top 133 can be made of metal (e.g. titanium) or of a synthetic material too. After the abutment basis 102 together with the insertion post 130 was removed from a suitable sterile housing 150 (e.g. a housing 150 according to FIG. 11), the abutment basis 102 is fixed on an implant 103 (e.g. by screwing), the implant being seated in the extraction alveole. In doing so, the abutment basis 102 is not directly touched, but the insertion post 130 serves as handling mean. After the abutment basis 102 is connected to the implant 103, the top 133 can be removed. A post remains on the abutment basis 102, which post looks like the post of FIG. 6D. This remaining post can serve as prosthetic post 210 for a provisional dental prosthesis. Later on, a different prosthetic post can be attached, before the final dental prosthesis (e.g. a crown 122 according to FIG. 10B) is permanently connected to the originally inserted abutment basis 102 by said prosthetic post.

Preferably, the insertion post 130 has a visible marking and/or perceptible marking in order to allow attaching the abutment basis 102 to the jaw of the patient in the correct orientation. The insertion post 130 of FIGS. 6D, 6E, 6F, 6G, 11, 12, 13 shows an incline in the region of the head or plate 131 and/or of the shaft 135, which incline defines the vestibular side. Instead of an incline, a different perceptible marking and/or visible marking can also be applicable in all embodiments.

Reference signs:

| | |
|---|---|
| Implant (post-shaped section) | 1 |
| Abutment | 2 |
| Flat surface | 3 |
| Scalloped surface | 4 |
| Jawbone | 5 |
| Connective tissue | 6 |
| Dental enamel | 7 |
| Nerve | 8 |
| Gingiva (Epithelium) | 9 |
| Dental prosthesis-implant | 10 |
| Dentin | 11 |
| Root of the tooth | 12 |
| Parodont | 13 |
| Collagen fibers | 14 |
| Interdental facial papilla | 15 |
| Incisors | FZ: 11, FZ: 12 |
| Incisors | FZ: 21, FZ: 22 |
| Canine teeth | EZ: 13, EZ: 23 |
| Premolar | PM: 14, PM: 15 |
| Premolar | PM: 24, PM: 25 |
| Implant system (Dental prosthesis-implant) | 100 |
| post-shaped section | 101 |
| Abutment basis | 102 |
| Implant | 103 |
| Scalloped surface | 104 |
| Circumferential ridge/shoulder | 105 |
| Outer thread | 106 |
| 1. Interface | 107 |
| Chamfer/reduction of diameter | 108 |
| Interface plane | 109 |
| Upper side | 110 |
| Concave lateral area | 111 |
| Apex | 112 |
| Curve | 113 |
| Curve | 114 |
| Connecting post/implant connection | 115 |
| Receiving opening | 116 |
| Through hole | 117 |
| Screw hole | 118 |
| Screw head | 119 |
| Set screw or screw | 120 |
| Collar or reduction of the diameter | 121 |
| Crown | 122 |
| Further interface | 123 |
| Complementary inner shape | 124 |
| Circumferential boarder | 125 |
| Further interface | 126 |
| Smooth section | 127 |
| Micro-rough section | 128 |
| Separation line | 129 |
| Insertion post | 130 |
| Head or plate | 131 |
| Head or handle region | 132 |
| Top | 133 |
| Groove | 134 |
| Shaft | 135 |
| Incline | 136 |
| Incline | 137 |
| Housing | 150 |
| Lid or plug | 151 |
| Abutment system | 200 |
| Prosthetic post | 210 |
| Head or plate | 211 |
| Notch | 212 |
| Notch | 213 |
| Shaft | 214 |
| Distance | a1 |
| Implant axis | AI |
| Molar tooth | BZ |
| Thickness | d1 |
| Foot print (in projection) | E1, E2, E3, E4 |
| Canine tooth | EZ |
| Planes | F1, F2, F3 |
| Bone level | KN1, KN2 |
| Level inside (oral) | NI |
| Level outside (vestibular) | NA |
| Upper edge | OK |
| Premolar | PM |
| Cross-sections | Q1, Q2, Q3, Q4 |
| Incisor | FZ |
| Cemento-enamel junction | SZG |
| Level of the cemento-enamel junction | SZGN1; SZGN2 |

1. Abutment system (200) for use in the area of anterior teeth and premolars with an abutment basis (102), which comprises a first interface (107) for placing onto an implant (103) and a further interface (126) for attaching a post (210, 130), wherein the abutment basis (102) has a three-dimensional shape, which is not symmetrically designed with respect to the implant axis (AI), and wherein the implant defines an implant axis (AI), characterized in that
the abutment basis (102) is designed as a one-time abutment basis (102),
the abutment system (200) comprises a separate insertion post (130), which is attachable in the region of an upper surface (104) of the abutment basis (102), wherein the insertion post (130) in the attached state extends coaxially with respect to the implant axis (AI),
the upper surface (104) of the abutment basis (102) is a scalloped upper surface (104) comprising the further interface (126) for attaching the insertion post (130), and
that the abutment basis (102) has a lateral area (111), whose soft tissue contact area (127, 128) is designed smooth and/or micro-rough and whose soft tissue contact area (127, 128) is designed hydrophilic or ultra-hydrophilic.

2. Abutment system (200) according to claim 1, characterized in that the abutment basis (102) and the insertion post (130) are provided industrially sterilized and with an intact hydrophilic or ultra-hydrophilic soft tissue contact area (127, 128).

3. Abutment system (200) according to claim 1, characterized in that the lateral area (111) has a concave shape (113, 114) if viewed in the vertical section.

4. Abutment system (200) according to claim 1, characterized in that the upper surface (104) of the abutment basis (102) is a scalloped upper surface (104) with an apex (112) and a circumferential ridge/shoulder (105), wherein the further interface (126) is arranged in the region of the apex (112).

5. Abutment system (200) according to claim 1, characterized in that the abutment basis (102), if viewed in the interdental side view, comprises a vestibular level (NA) and a different oral level (NI), wherein the vestibular level (NA) is located below the oral level (NI).

6. Abutment system (200) according to claim 1, characterized in that the lateral area (111), which has a concave shape (113, 114) if viewed in the vertical section, creates a transition free from edges from a proximal interface plane (109) to the circumferential ridge/shoulder (105), wherein the proximal interface plane (109) stands perpendicularly with respect to the implant axis (AI).

7. Abutment system (200) according to claim 1, characterized in that the circumferential ridge/shoulder (105), if viewed in the interdental side view, has a scalloped shape and that the soft tissue contact area of the circumferential ridge/shoulder (105) is smooth.

8. Abutment system (200) according to claim 1, characterized in that the abutment basis (102) comprises:
a proximal interface plane (109) in the region of the first interface (107), wherein the proximal interface plane (109) is essentially flat and stands perpendicularly with respect to the implant axis (AI),
a through hole (117) in the region of the scalloped upper surface (104) for attaching the insertion post (130), wherein the through hole (117) essentially extends parallel, preferably coaxially, to the implant axis (AI).

9. Abutment system (200) according to claim 1, characterized in that the abutment basis (102) has, if viewed in the horizontal section, an elliptical shape of the foot print (E1) or a rounded deltoid shape of the foot print (E2, E3, E4).

10. Abutment system (200) according to claim 9, characterized in that the shape of the foot print (E1, E2, E3, E4) of the abutment basis (102) is adapted to the shape of the foot print (Q1, Q2, Q3, Q4) of an incisor (SZ), canine (EZ) or premolar tooth (PM) to be replaced by a dental prosthesis-implant (100).

11. Abutment system (200) according to claim 1, characterized in that the first interface (107) is designed for rotation locked placing the abutment basis (102) on the implant element (103) in at least three different index positions with respect to the implant axis (AI).

12. Abutment system (200) according to claim 1, characterized in that the abutment basis (102) in the region of the first interface (107) comprises
a connecting post for an internal implant connection (115), or
a receiving opening for an external implant connection (115).

13. Abutment system (200) according to claim 1, characterized in that the first interface (107) is designed as hex-interface, which enables to put the abutment basis (102) onto the implant element (103) in one of six different index positions with respect to the implant axis (AI).

14. Abutment system (200) according to claim 1, characterized in that the abutment basis (102) is designed for immediate implantation in the mucous area, wherein the abutment basis (102) including the insertion post (130) are provided sterilely packed.

15. Abutment system (200) according to claim 1, characterized in that the abutment basis (102) and the insertion post (130) are provided connected to each other, wherein the insertion post (130) after immediate implantation is separable from the abutment basis (102) and wherein the abutment basis (102) remains in the patient.

16. Abutment system (200) according to claim 1, characterized in that the lateral area (111) comprises a micro-rough section (128) and a smooth section (127), wherein a separation line (129), which defines the transition between the micro-rough section (128) and the smooth section (127) of the soft tissue contact area, has in particular a scalloped, asymmetric shape.

17. Dental prosthesis-implant (100) with an abutment system (200) according to claim 1 and with an implant (103), characterized in that the implant (103) comprises a post-shaped section (101) with outer thread and that the implant (103) is implemented separately from the abutment basis (102), wherein the implant (103) comprises a base body, which is essentially rotationally symmetric with respect to the central implant axis (AI), and wherein the abutment basis (102) is provided with an insertion post (130) being removably attached to the base body.

18. Dental prosthesis-implant (100) according to claim 17, characterized in that the implant (103) has a central bore (118), which runs coaxially with respect to the implant axis (AI) and which is provided with an inner thread to removably attach the insertion post (130).

19. Dental prosthesis-implant (100) according to claim 17, characterized in that a circumferential chamfer (108) is provided in the region of the first interface (107) at the implant (103) and/or at a proximal interface plane (109) of the abutment basis (102) in order to promote the bone apposition and/or the tissue apposition after the implantation.

20. Dental prosthesis-implant (100) according to claim 17, characterized in that the implant (103), if viewed from a proximal position to a distal position, has a reduction of the circumference (108) in the region of a distal upper surface (110), that the abutment basis (102) sits with its proximal interface plane (109) flat on the distal upper surface (110) of the implant (103), and that the lateral area (111) of the abutment basis (102) follows directly or with a small distance to the reduction of the circumference (108), which lateral area has a concave shape (113, 114) if viewed in the vertical section.

21. Dental prosthesis-implant (100) according to claim 17 for implantation in a position in which the scalloped upper surface (104) of the abutment basis (102) lies supracrestally and in which the micro-rough section (128) and/or the smooth section (127) of the lateral area (111) lies inside the soft tissue.

22. Implant set, which comprises at least two abutment basis (102), wherein each abutment basis (102) of the implant set has a different foot print shape (E1, E2, E3, E4) and/or size and wherein each abutment basis (102) comprises a first interface (107) for placing onto an implant (103) and a further interface (126) for attaching an insertion post (130), wherein the abutment basis (102) has a three-dimensional shape, which is not symmetrically designed with respect to the implant axis (AI), and wherein the implant defines an implant axis (AI), characterized in that
the implant set comprises at least one insertion post (130), which is attachable in the region of a upper surface (104) of the abutment basis (102), or which is attachable in the region of the upper surface (104) of one of the abutment basis (102),
the insertion post (130) in the attached state extends coaxially with respect to the implant axis (AI),
the upper surface (104) of each of the abutment basis (102) has a scalloped upper surface (104),
and that the abutment basis (102) has a lateral area (111), whose soft tissue contact area is designed hydrophilic or ultra-hydrophilic.

23. Implant set according to claim 22, characterized in that
the abutment basis (102) comprises a first level (NA) and a different second level (NI) if viewed in the interdental side view, and/or
the lateral area (111) has a concave shape (113, 114) if viewed in the vertical section.

24. Implant set according to claim 22, characterized in that the lateral area (111) comprises a micro-rough section (128) and a smooth section (127), wherein a separation line (129), which defines the transition between the micro-rough section (128) and the smooth section (127) of the soft tissue contact area, in particular has a scalloped, asymmetric shape.
